(19) United States
(12) Patent Application Publication
(10) Pub. No.: US 2004/0181345 A1
(43) Pub. Date: Sep. 16, 2004

(54) Processing of chemical analysis data

(76) Inventors: Evgueni Kolossov, Berkshire (GB); Dmitri Zouchinski, West Sussex (GB)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/772,635

(22) Filed: Feb. 4, 2004

(30) Foreign Application Priority Data
Feb. 5, 2003 (GB) 0302607.7

(51) Int. Cl. G01N 31/00; G06F 19/00

(52) U.S. Cl. 702/22

(57) ABSTRACT

A method for processing chemical analysis data is disclosed. The method includes including a step of cluster analysis, the cluster analysis using a distance metric of the form:

$${D}_{xy} = \frac{{\sum }_{i} {( ( \frac{{x}_{i} - {c}_{i}}{{s}_{i}} ) - ( \frac{{y}_{i} - {c}_{i}}{{s}_{i}} ) )}^{2}}{\sqrt{( {\sum }_{i} {( \frac{{x}_{i} - {c}_{i}}{{s}_{i}} )}^{2} ) \times ( {\sum }_{i} {( \frac{{y}_{i} - {c}_{i}}{{s}_{i}} )}^{2} )}}$$

In performance of cluster analysis, the value of the metric increases with difference in angle cc between vectors rₓ and r_{y} starting in the co-ordinate centre and pointing at the points X and Y. The value of the metric also increases with difference between lengths of vectors rₓ and r_{y} but this difference is normalised by their length. This means that points located on the tail of the distribution can pass the threshold even though they are further away from each other than points inside the standard deviation range.

### BACKGROUND TO THE INVENTION

1. Field of the Invention

This invention relates to processing of chemical analysis data. Chemical analysis techniques such as quantitative structure-activity relationship (QSAR) and quantitative structure-property (QSPR) produce a large amount of numerical data that must be analysed. A particularly important part of the analysis is cluster analysis, which attempts to identify components of the data that are grouped together in one or more clusters within a multi-dimensional data space. The aim in performing this analysis is to group structure fragments with similar descriptors. This can simplify analysis of the data, and reveal new dependencies and relations between data points.

Clustering algorithms must make a trade-off between accuracy and speed. The fastest algorithms can perform their analysis with one pass through the data, while more complex algorithms may require multiple passes. For large data sets, the time required to process the data may impose a limit upon the maximum acceptable degree of complexity of the algorithm. Central to the clustering algorithm is a metric, which describes data dissimilarity. The choice of metric, of which several are in common use, will pre-define the results of the cluster analysis and the time taken to perform it.

2. Summary of the Prior Art

A wide range of metrics are known, including Euclidean distance, squared Euclidean, city-block (Manhattan), Chebyehev, and power distances. They all work well with normalised multi-dimensional data within a one standard deviation range of the centre of the distribution. This is because the probability that a point has a certain co-ordinate does not vary significantly within the standard deviation range. However, analysis of points occupying the tails of co-ordinate distribution reveals weaknesses in these known metrics. Discriminative single-pass cluster analysis uses a threshold to highlight points located close together. It is possible to describe this by the probability of the event that these points happened to be close to each other by chance. The probability of two independent events occurring together is multiplication of individual probabilities and the probability that the point is inside the standard deviation range is much higher than on the tail of the distribution. This means that there should be different thresholds for points inside the standard-deviation range and for points located on the distribution tail. When one threshold is used for both cases, then one of two problems may arise. Either, clusters located on the tails of distribution are not identified (if the threshold is too high) or clusters located within standard deviation range are merged (if the threshold is too low).

### SUMMARY OF THE INVENTION

An aim of this invention is to provide a metric for describing the similarity of multi-dimensional data that can be calculated efficiently and that can provide satisfactory analysis of data in the tails of a cluster as well as close to the centre of a cluster.

To this end, the invention provides a method of analysing chemical data including a step of cluster analysis, the cluster analysis using a distance metric of the form:

$${D}_{xy} = \frac{{\sum }_{i} {( ( \frac{{x}_{i} - {c}_{i}}{{s}_{i}} ) - ( \frac{{y}_{i} - {c}_{i}}{{s}_{i}} ) )}^{2}}{\sqrt{( {\sum }_{i} {( \frac{{x}_{i} - {c}_{i}}{{s}_{i}} )}^{2} ) \times ( {\sum }_{i} {( \frac{{y}_{i} - {c}_{i}}{{s}_{i}} )}^{2} )}}$$

In a special case, applicable where the data to be analysed is 2-dimensional or 3-dimensional, the invention provides a method of analysing chemical data including a step of cluster analysis, the cluster analysis using a distance metric for the distance between point x and point y of the form:

$$D ( x , y ) = 4 {sin}^{2} ( \frac{α}{2} ) + \frac{{( {r}_{x} - {r}_{y} )}^{2}}{{r}_{x} \cdot {r}_{y}} ,$$

where α is the angle between point x and point y and rₓ and r_{y} are, respectively, the distances from the co-ordinate origin to point x and point y.

In each case, the calculated distance metric D is relative to a point and to the centre of all points under analysis.

It should be noted that this is not a distinct metric from that given above. Rather, it is a different description of that metric when applied to low-dimensional data.

Consider this metric as it is applied to two-dimensional or three-dimensional spaces. The value of the metric increases with difference in angle α between vectors rₓ and r_{y} starting in the co-ordinate centre and pointing at the points X and Y. The value of the metric also increases with difference between lengths of vectors rₓ and r_{y} but this difference is normalised by their geometric mean length. This means that points located on the tail of the distribution can pass the threshold even though they are further away from each other than points inside the standard deviation range.

This metric can be performed in a single pass through the data; therefore it requires comparatively few processing steps and does not require memory for storage of intermediate results. Specifically, to calculate the metric, squared Euclidian distances are calculated between points in a matrix of N points by N points and each point and the co-ordinate centre; a vector of N points). The memory required for each additional vector is 1/N^{th} of memory required for distance matrix and therefore insignificant. Moreover, the number of calculations required for additional vector is 1/N^{th} of calculations required for distance matrix. Having calculated these distance matrix and vector it is possible in one pass apply two thresholds:

Threshold for squared Euclidian distance; and

Threshold for the metric of the invention.

All points with metrics below a threshold are treated as being elements of a cluster. Anything that has been left over after that can be processed by complex, multi-pass methods such as hierarchical cluster analysis and K-means cluster analysis.

A method embodying the invention typically includes a step of performing principal component analysis on the data prior to the clustering step. Clustering is then performed only upon data identified as being non-correlated.

In order to simplify the clustering process, a method embodying the invention advantageously includes a step of normalising the data prior to the clustering step. For example, the normalising step may modify the data such that it has a mean value of 0 and a standard deviation of 1.

A typical analysis method embodying the invention may further include cluster analysis by conventional metrics, for example, the distance metric. The further cluster analysis may, for example, be applied to data not previously assigned to a cluster. Since this step operates on a smaller data set than the initial clustering step, it may include a more processor-intensive metric.

From a second aspect, this invention provides a computer program product for performing analysis of chemical data, the program being operative to perform a method according to the first aspect of the invention.

### BRIEF DESCRIPTION OF THE DRAWING

FIG. 1 is a block diagram of an analysis embodying the invention.

### DETAILED DESCRIPTION OF THE PREFERRED EMBODIMENT

An embodiment of the invention will now be described in detail, by way of example, and with reference to the accompanying drawings.

The embodiment of the invention processes a multi-dimensional set of data that is generated from the results of multiple chemical analyses, for example, form a quantitative structure-activity relationship (QSAR) or a quantitative structure-property (QSPR) programme. The chemical analyses are performed using conventional analysts apparatus and methods and the results are stored in a machine-readable file. The file is then read by analysis software executing on a computer to generate an analysis output that can be interpreted by a person or be passed to another computer system or computer program for further analysis.

Described below is one possible way in which a cluster analysis can be performed in accordance with the invention. This method is implemented within the analysis software. Since the clustering analysis method and code can be a direct replacement for clustering analysis and code previously embedded within analysis software, only the novel and inventive clustering components will be described since other components of analysis software will be well-known to those skilled in the technical field.

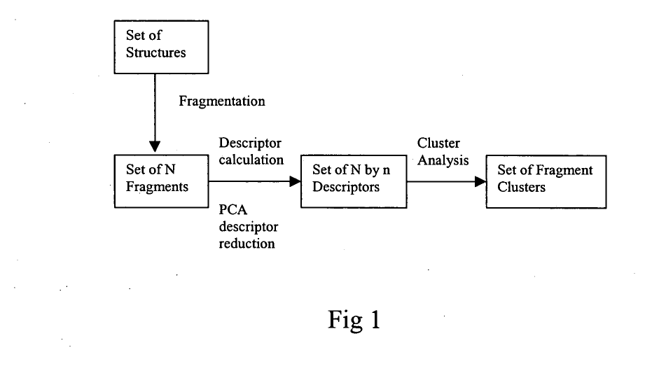

In the analysis, the data is subject to five principle processing steps, as will now be described. These steps and the data that they produce and operate upon are shown in FIG. 1.

First, the data is subject to a process of principal component analysis. This has the effect of reducing the dimensionality of the data by identifying non-correlated descriptors, which will be included in subsequent analyses. F-Test significance is used to specify discrimination level for the residual that there will be if multiple linear regression has been performed on the descriptor as a linear combination of significant descriptors with weights.

Then, the matrix of non-correlated descriptors dᵢⱼ is normalised to produce a matrix of normalised descriptors dᵢⱼ* with zero mean and a standard deviation of unity for each descriptor. Given that:

$$Mean ( {d}_{j} ) = \frac{{\sum }_{i} ( {d}_{ij} )}{N} ,$$

where N is number of fragments, i is the fragment index and j is the descriptor index; and

$$StdDeviation ( {d}_{j} ) = \sqrt{\frac{{\sum }_{i} {( {d}_{ij} - Mean ( {d}_{j} ) )}^{2}}{N - 1}} , then$$

$${d}_{ij}^{*} = \frac{{d}_{ij} - Mean ( {d}_{j} )}{StdDeviation ( {d}_{j} )}$$

Then, the matrix D² of the size N×N is calculated along with the vector R² of the size N as follows:

$${D}_{ij}^{2} = {\sum }_{k} {( {d}_{jk}^{*} - {d}_{ik}^{*} )}^{2}$$

$${R}_{i}^{2} = {\sum }_{k} {d}_{ik}^{2}$$

Next, the cluster analysis is performed in two stages. First, a single-pass discriminative cluster analysis “squared Euclidian” with two thresholds for normalised square of distance:

$$( \frac{{D}_{ij}^{2}}{N} )$$

and, in accordance with the invention, with what will be referred to as the “radar metric”

$$\frac{{D}_{ii}^{2}}{{( {R}_{i}^{2} * {R}_{i}^{2} )}^{0.5}}$$

Finally, a hierarchical cluster analysis can be performed for the rest of the fragments that remained non-clustered after application of the radar metric. This can be used to refine the results produced by the cluster analysis of the radar metric. Since the further analysis is applied to a smaller data set than that analysed by the radar metric, it may be inherently more complex without giving rise to an unacceptable increase in processing time. For example, it may include use of a metric such as Euclidean distance, squared Euclidean, city-block (Manhattan), Chebyehev, and power distances. Other methods include multi-pass techniques such as hierarchical cluster analysis and K-means cluster analysis. (Different types of metrics are used in other application areas, selected in accordance with the nature of the subject. For example, city-block is used to calculate distance in a city with no diagonal streets).

To summarise: Point X has co-ordinates {xᵢ}. Each co-ordinate has mean cᵢ and standard deviation sᵢ.

Normalised co-ordinates have zero mean and standard deviation equal to unity. The normalised co-ordinates for point X are {(xᵢ−cᵢ)/sᵢ} and point Y has normalised co-ordinates as {(yᵢ−cᵢ)/sᵢ}.

Squared Euclidian Distance between X and Y is

D²=Σᵢ((xᵢ−cᵢ)/sᵢ−(yᵢ−cᵢ)/sᵢ)²

Squared Euclidian Distance between X and C (centre of co-ordinates) is

Rₓ²=Σᵢ((xᵢ−cᵢ)/sᵢ)²

Squared Euclidian distance between Y and C (centre of co-ordinates) is

R_{y}²=Σᵢ((yᵢ−cᵢ)/sᵢ)²

Radar metric is squared Euclidian distance normalised on geometric mean of squared Euclidian distances from co-ordinate centre:

D²/(Rₓ²*R_{y}²)^{0.5}

D_{xy}=D²/(Rₓ²*R_{y}²)^{0.5}=(Σᵢ((xᵢ−cᵢ)/sᵢ−(yᵢ−cᵢ)/sᵢ)²)/(Σᵢ((xᵢ−cᵢ)/sᵢ)²*Σᵢ((yᵢ−cᵢ)/sᵢ)²)^{0.5}

Which expands to:

$${D}_{xy} = \frac{{\sum }_{i} {( ( \frac{{x}_{i} - {c}_{i}}{{s}_{i}} ) - ( \frac{{y}_{i} - {c}_{i}}{{s}_{i}} ) )}^{2}}{\sqrt{( {\sum }_{i} {( \frac{{x}_{i} - {c}_{i}}{{s}_{i}} )}^{2} ) \times ( {\sum }_{i} {( \frac{{y}_{i} - {c}_{i}}{{s}_{i}} )}^{2} )}} .$$

What is claimed is:

1. A method of analysing chemical data including a step of cluster analysis, the cluster analysis using a distance metric of the form:
$${D}_{xy} = \frac{{\sum }_{i} {( ( \frac{{x}_{i} - {c}_{i}}{{s}_{i}} ) - ( \frac{{y}_{i} - {c}_{i}}{{s}_{i}} ) )}^{2}}{\sqrt{( {\sum }_{i} {( \frac{{x}_{i} - {c}_{i}}{{s}_{i}} )}^{2} ) \times ( {\sum }_{i} {( \frac{{y}_{i} - {c}_{i}}{{s}_{i}} )}^{2} )}} .$$

2. A method according to claim 1 that includes a step of performing principal component analysis on the data prior to the clustering step.

3. A method according to claim 1 that further includes a step of normalising the data prior to the clustering step.

4. A method according to claim 3 in which the normalising step modifies the data such that it has a mean value of 0 and a standard deviation of 1.

5. A method according to claim 1 that includes a further step of cluster analysis using a conventional distance metric.

6. A method according to claim 5 in which the further step of cluster analysis is applied to data that has not previously been assigned to a cluster.

7. A method according to claim 6 suitable for operation upon a set of data derived from the results of a chemical analysis programme.

8. A method according to claim 7 in which the analysis programme includes one or both of a quantitative structure-activity relationship (QSAR) analysis and a quantitative structure-property relationship (QSPR) analysis.

9. A method of analysing chemical data including a step of cluster analysis on 2-dimensional or 3-dimensional data, the cluster analysis using a distance metric for the distance between point x and point y of the form:
$$D ( x , y ) = 4 {sin}^{2} ( \frac{α}{2} ) + \frac{{( {r}_{x} - {r}_{y} )}^{2}}{{r}_{x} {r}_{y}} ,$$
where α is the angle between point x and point y and rₓ and r_{y} are, respectively, the distances from the co-ordinate origin to point x and point y.

10. A method according to claim 9 that includes a step of performing principal component analysis on the data prior to the clustering step.

11. A method according to claim 9 that further includes a step of normalising the data prior to the clustering step.

12. A method according to claim 11 in which the normalising step modifies the data such that it has a mean value of 0 and a standard deviation of 1.

13. A method according to claim 9 that includes a further step of cluster analysis using a conventional distance metric.

14. A method according to claim 13 in which the further step of cluster analysis is applied to data that has not previously been assigned to a cluster.

15. A method according to claim 9 suitable for operation upon a set of data derived from the results of a chemical analysis programme.

16. A method according to claim 15 in which the analysis programme includes one or both of a quantitative structure-activity relationship (QSAR) analysis and a quantitative structure-property relationship (QSPR) analysis.

17. A computer program product for performing analysis of chemical data, the program being operative to perform a method including a step of cluster analysis, the cluster analysis using a distance metric of the form:
$${D}_{xy} = \frac{{\sum }_{i} {( ( \frac{{x}_{i} - {c}_{i}}{{s}_{i}} ) - ( \frac{{y}_{i} - {c}_{i}}{{s}_{i}} ) )}^{2}}{\sqrt{( {\sum }_{i} {( \frac{{x}_{i} - {c}_{i}}{{s}_{i}} )}^{2} ) \times ( {\sum }_{i} {( \frac{{y}_{i} - {c}_{i}}{{s}_{i}} )}^{2} )}} .$$

18. A computer program product according to claim 17 that has as an input a set of machine-readable data representative of the results of a chemical analysis programme.

19. A computer program product according to claim 18 in which the analysis programme includes a quantitative structure-activity relationship (QSAR) analysis and a quantitative structure property relationship (QSPR) analysis.

20. A computer program product for performing analysis of chemical data, the program being operative to perform a method including a step of cluster analysis on 2-dimensional or 3-dimensional data, the cluster analysis using a distance metric of the form:
$$D ( x , y ) = 4 {sin}^{2} ( \frac{α}{2} ) + \frac{{( {r}_{x} - {r}_{y} )}^{2}}{{r}_{x} \cdot {r}_{y}} ,$$
where α is the angle between point x and point y and rₓ and r_{y} are, respectively, the distances from the co-ordinate origin to point x and point y.

21. A computer program product according to claim 20 that has as an input a set of machine-readable data representative of the results of a chemical analysis programme.

22. A computer program product according to claim 21 in which the analysis programme includes a quantitative structure-activity relationship (QSAR) analysis and a quantitative structure-property relationship (QSPR) analysis.
